(19) United States
(12) Patent Application Publication
(10) Pub. No.: US 2024/0345390 A1
(43) Pub. Date: Oct. 17, 2024

(54) VEHICLE DISPLAY DEVICE

(71) Applicant: YAZAKI CORPORATION, Tokyo (JP)

(72) Inventor: Noriaki NARUSHIMA, Susono-shi, Shizuoka (JP)

(21) Appl. No.: 18/754,157

(22) Filed: Jun. 26, 2024

Related U.S. Application Data
(63) Continuation of application No. PCT/JP2023/007972, filed on Mar. 3, 2023.

(30) Foreign Application Priority Data
Mar. 9, 2022 (JP) 2022-036015

(51) Int. Cl. G02B 27/01

(52) U.S. Cl. CPC G02B 27/0101; G02B 2027/0118

(57) ABSTRACT

A vehicle display device includes a housing that has an opening facing a windshield, an image display device that outputs display light of an image, a mirror that reflects the display light toward the windshield, and a transparent cover that is disposed in the opening, in which the cover has an outer surface facing the windshield and an inner surface facing the mirror, and has a shape curved toward the inside of the housing in a cross section orthogonal to an image lateral direction, the inner surface is a free-form surface formed to correct distortion or aberration of the image, and an angular difference between the outer surface and the inner surface in the cross section is set to a value within a range in which external light incident on the inside of the cover from the outer surface is not totally reflected inside the cover.

### CROSS-REFERENCE TO RELATED APPLICATION

This application is a continuation application of International Application No. PCT/JP2023/007972 filed on Mar. 3, 2023 which claims the benefit of priority from Japanese Patent Application No. 2022-036015 filed on Mar. 9, 2022 and designating the U.S., the entire contents of which are incorporated herein by reference.

### BACKGROUND OF THE INVENTION

### 1. Field of the Invention

The present invention relates to a vehicle display device.

### 2. Description of the Related Art

Hitherto, there is a vehicle display device such as a head-up display. Japanese Patent Application Laid-open No. 2008-268883 discloses a head-up display device including optical means that gives an optical effect to light in a preset specific direction and transmits the light, and image projection means that projects image light to reflection means via the optical means.

It is desirable that display quality can be improved without increasing the number of components of the vehicle display device. For example, if distortion or the like of an image can be corrected by a transparent cover provided in a housing, addition of a component becomes unnecessary. Here, when the shape of the cover is designed based on the correction function, it is necessary to pay attention so that ghosting due to external light does not occur.

### SUMMARY OF THE INVENTION

An object of the present invention is to provide a vehicle display device capable of achieving both improvement in image quality and suppression of ghosting. In order to achieve the above mentioned object, a vehicle display device according to one aspect of the present invention includes: a housing that is mounted on a vehicle and has an opening facing a windshield; an image display device that is disposed inside the housing and outputs display light of an image; a mirror that is disposed inside the housing, faces the windshield via the opening, and reflects the display light toward the windshield; and a transparent cover that is disposed in the opening, wherein the cover has an outer surface facing the windshield and an inner surface facing the mirror, and has a shape curved toward an inside of the housing in a cross section orthogonal to an image lateral direction, the inner surface is a free-form surface formed to correct distortion or aberration of the image, and an angular difference between the outer surface and the inner surface in the cross section is set to a value within a range in which external light incident on an inside of the cover from the outer surface is not totally reflected inside the cover.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a vehicle on which a vehicle display device according to an embodiment is mounted;

FIG. 2 is a perspective view of the vehicle display device according to the embodiment;

FIG. 3 is a cross-sectional view of the vehicle display device according to the embodiment;

FIG. 4 is a view illustrating external light incident on a cover according to the embodiment; and

FIG. 5 is a view illustrating external light incident on a cover of a comparative example.

### DETAILED DESCRIPTION OF THE PREFERRED EMBODIMENTS

Hereinafter, a vehicle display device according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

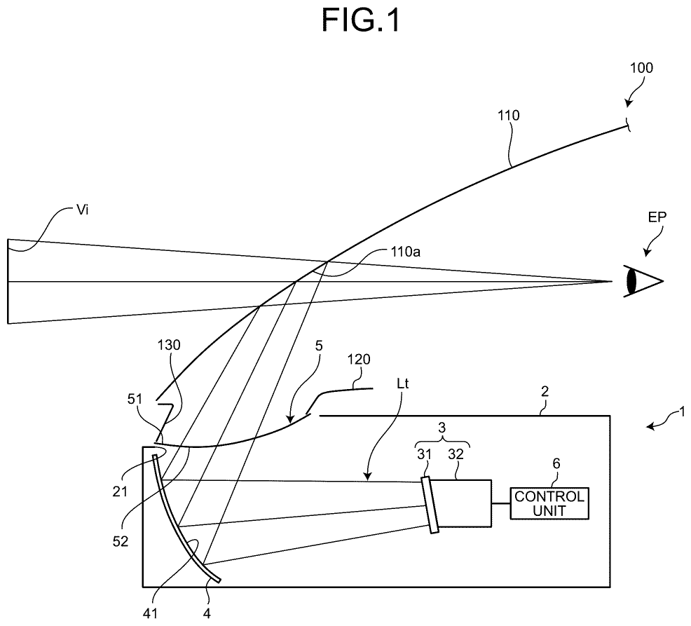

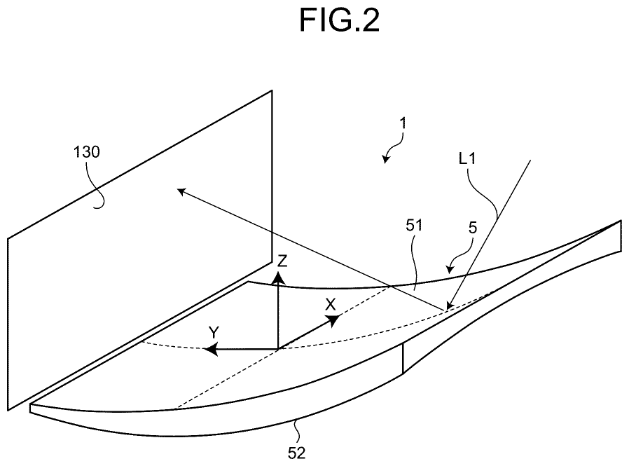

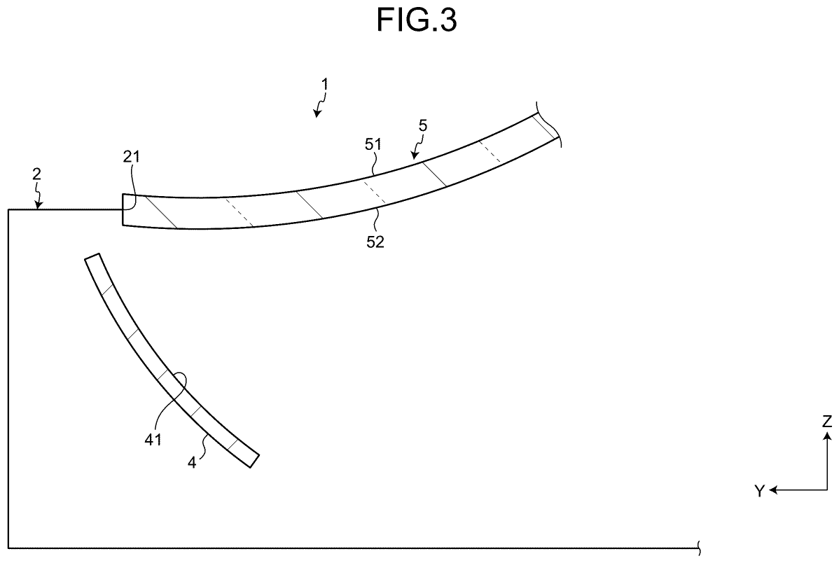

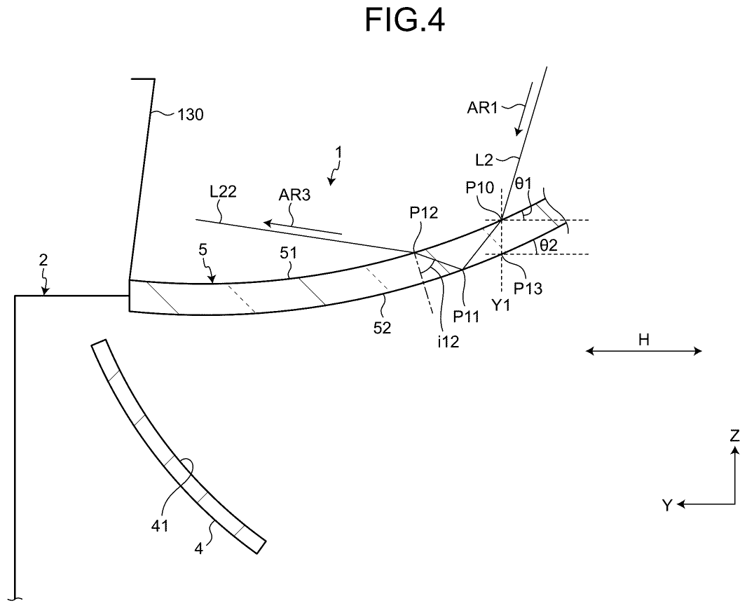

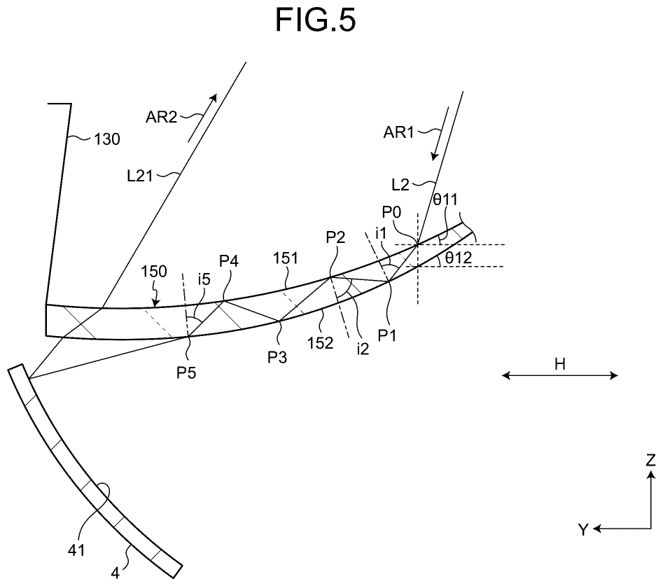

An embodiment will be described with reference to FIGS. 1 to 5. The present embodiment relates to a vehicle display device. FIG. 1 is a view illustrating a vehicle on which the vehicle display device according to the embodiment is mounted, FIG. 2 is a perspective view of the vehicle display device according to the embodiment, FIG. 3 is a cross-sectional view of the vehicle display device according to the embodiment, FIG. 4 is a view illustrating external light incident on a cover of the embodiment, and FIG. 5 is a view illustrating external light incident on a cover of a comparative example.

As illustrated in FIG. 1, a vehicle display device 1 according to the present embodiment is a head-up display device mounted on a vehicle 100 such as an automobile. The vehicle display device 1 projects display light Lt of an image toward a windshield 110. The display light Lt is reflected toward the eye point EP by a reflective surface 110a of the windshield 110. A driver of the vehicle 100 can visually recognize a virtual image Vi by the display light Lt. The virtual image Vi may be displayed in such a way as to be superimposed on an object in front of the vehicle 100. The virtual image Vi may be a meter image for the vehicle 100.

The vehicle display device 1 includes a housing 2, an image display device 3, a mirror 4, a cover 5, a control unit 6, and a facing 130. The housing 2 is disposed on the front side of the vehicle and in front of the eye point EP, and is housed in, for example, an instrument panel 120. The housing 2 is formed of a light-blocking material. The housing 2 has an opening 21 facing the windshield 110 in a vehicle top-bottom direction. The illustrated opening 21 is disposed on an upper surface of the housing 2 and is positioned at a front end portion of the housing 2.

The image display device 3 and the mirror 4 are disposed inside the housing 2. The image display device 3 is a device that outputs the display light Lt of the image. The illustrated image display device 3 includes a display 31 and a backlight unit 32. The display 31 is, for example, a liquid crystal display device such as a thin film transistor-liquid crystal display (TFT-LCD). The image display device 3 generates the display light Lt by light of the backlight unit 32. The display 31 and the backlight unit 32 are controlled by the control unit 6.

The mirror 4 is a reflective member that reflects the display light Lt toward the windshield 110. The mirror 4 has a concave reflective surface 41, and is configured to be able to enlarge the image. The reflective surface 41 of the mirror 4 is, for example, a free-form surface having an image correction function. More specifically, a shape of the reflective surface 41 is designed to correct image distortion caused when the display light Lt is reflected by the reflective surface 110a of the windshield 110. The display light Lt reflected by the reflective surface 41 is further reflected by the windshield 110 toward the eye point EP.

The cover 5 is disposed in the opening 21 of the housing 2 and closes the opening 21. The cover 5 is a transparent member, and is molded using, for example, a transparent resin. The cover 5 has a shape curved toward the inside of the housing 2. The curved shape of the cover 5 is determined in such a way as to reflect external light toward the facing 130. The facing 130 is a light-blocking wall provided on the instrument panel 120. The facing 130 has a low reflectance and can absorb external light. A surface shape of the facing 130 may be a shape that diffuses light. The housing 2 is disposed in such a way that the cover 5 is positioned on a rear side of the vehicle and behind the facing 130. That is, the facing 130 is disposed on the front side of the vehicle and in front of the cover 5 and extends in the vehicle top-bottom direction.

The cover 5 has an outer surface 51 and an inner surface 52. The outer surface 51 is a surface facing the upper side of the vehicle, and faces the windshield 110. The inner surface 52 faces a lower side of the vehicle and faces the mirror 4.

FIG. 2 is a perspective view of the cover 5. The cover 5 has a first direction X, a second direction Y, and a third direction Z. The first direction X is a direction corresponding to the image lateral direction of the virtual image Vi, and the second direction Y is a direction corresponding to an image longitudinal direction of the virtual image Vi. The third direction Z is the vehicle top-bottom direction. The third direction Z is, for example, orthogonal to the first direction X. As illustrated in FIGS. 1 and 3, the cover 5 has a shape curved toward the inside of the housing 2 on a YZ plane. The YZ plane is a cross section orthogonal to the image lateral direction. A shape of the outer surface 51 on the YZ plane is a curved shape, for example, an arc shape. The outer surface 51 is curved downward in the vehicle top-bottom direction. A shape of the outer surface 51 on an XZ plane is, for example, a linear shape.

As illustrated in FIG. 2, the outer surface 51 is formed to reflect external light L1 toward the facing 130. The outer surface 51 has, for example, a shape capable of reflecting, toward the facing 130, the external light L1 transmitted through the windshield 110 and incident on the outer surface 51. The facing 130 can suppress external light reflected by the cover 5 from moving toward the eye point EP, and can improve visibility of the virtual image Vi.

The inner surface 52 is a free-form surface. For example, a shape of the inner surface 52 on the YZ plane and a shape of the inner surface 52 on the XZ plane are free curves. The shape of the inner surface 52 is determined in such a way as to correct image distortion or aberration. The inner surface 52 is designed to correct, for example, at least one of distortion occurring on the reflective surface 41 of the mirror 4 or distortion occurring on the reflective surface 110a of the windshield 110. The inner surface 52 is designed to correct, for example, at least one of aberration occurring on the reflective surface 41 or aberration occurring on the reflective surface 110a. The inner surface 52 may correct both image distortion and aberration, and may correct either image distortion or aberration.

In the cover 5 of the present embodiment, since the inner surface 52 is a free-form surface, an angular difference occurs between the outer surface 51 and the inner surface 52. FIG. 4 illustrates inclination angles θ1 and θ2 of the outer surface 51 and the inner surface 52 with respect to a reference direction H. The inclination angles θ1 and θ2 are angles on the YZ plane, that is, angles in a cross section orthogonal to the image lateral direction. The reference direction H is a direction common to the outer surface 51 and the inner surface 52, and is, for example, a horizontal direction.

The first inclination angle θ1 is an inclination angle of the outer surface 51 with respect to the reference direction H. The second inclination angle θ2 is an inclination angle of the inner surface 52 with respect to the reference direction H. In the following description, an angular difference between the first inclination angle θ1 and the second inclination angle θ2 is simply referred to as an “angular difference Δθ”. A unit of angle is, for example, [°].

$$Δ θ = θ 1 - θ 2 \qquad ( 1 )$$

Since the cover 5 is curved, the first inclination angle θ1 and the second inclination angle θ2 are changed according to a position in the second direction Y. In the illustrated cover 5, the inclination angles θ1 and θ2 decrease toward the front side of the vehicle. Values of the inclination angles θ1 and θ2 in Formula (1) above are values of angles of portions facing each other in the outer surface 51 and the inner surface 52. For example, in FIG. 4, a point P10 and a point P13 face each other in the third direction Z. The points P10 and P13 are points at the same position Y1 in the second direction Y. The angular difference Δθ at the position Y1 is calculated from the first inclination angle θ1 at the point P10 and the second inclination angle θ2 at the point P13.

As described below, in the present embodiment, the value of the angular difference Δθ is determined in such a way as not to totally reflect external light inside the cover 5. That is, in an optical design of the inner surface 52, a restriction is provided in such a way that the angular difference Δθ is a value within a predetermined range.

First, a problem in a case where external light is totally reflected inside the cover will be described. FIG. 5 illustrates a cover 150 of a comparative example. The cover 150 of the comparative example has an outer surface 151 and an inner surface 152. An angular difference between an inclination angle θ11 of the outer surface 151 and an inclination angle θ12 of the inner surface 152 is larger than the angular difference Δθ of the present embodiment. FIG. 5 illustrates external light L2 incident on the outer surface 151. The external light L2 is, for example, light transmitted through a windshield 110 and incident on the cover 150. The external light L2 is light directed from the rear side to the front side of the vehicle 100 as indicated by an arrow ARI, and is incident on the outer surface 151 from obliquely above. The external light L2 illustrated in FIG. 5 is incident on the inside of the cover 150 from a point PO on the outer surface 151.

The external light L2 is reflected at points P1, P2, P3, and P4 inside the cover 150, and is emitted to the outside from a point P5. The points P2 and P4 are points on the outer surface 151, and the points P1, P3, and P5 are points on the inner surface 152. In a case where the angular difference between the inclination angles θ11 and θ12 is large, the external light L2 is easily totally reflected inside the cover 150. For example, in the cover 150 of the comparative example, the inclination angle θ12 is larger than the inclination angle θ11. As a result, an incident angle i2 with respect to the point P2 is larger than an incident angle i1 with respect to the point P1. Furthermore, since the outer surface 151 and the inner surface 152 are curved downward, an angular difference between the incident angle i1 and the incident angle i2 tends to be large. As a result, the incident angle of the external light L2 tends to be an angle of total reflection inside the cover 150.

In FIG. 5, for example, the external light L2 is totally reflected at the points P2, P3, and P4. Therefore, the external light L2 travels inside the cover 150 without undergoing attenuation in light amount. An incident angle 15 at the point P5 is an angle smaller than a critical angle. Therefore, the external light L2 is emitted to an external space at the point P5.

The external light L2 emitted from the inner surface 152 is reflected by a mirror 4 and is transmitted through the cover 150. In a case where light L21 transmitted through the cover 150 travels upward as indicated by an arrow AR2, ghosting may occur. For example, when the light L21 is reflected by the windshield 110 toward an eyellipse, external light may reach the eyes of the driver.

On the other hand, the cover 5 of the present embodiment is configured not to totally reflect the external light L2 inside the cover 5. As illustrated in FIG. 4, the external light L2 is incident on the inside of the cover 5 from the point P10. A part of the external light L2 is reflected at a point P11 on the inner surface 52 and is incident on a point P12 on the outer surface 51. The cover 5 is designed in such a way that an incident angle i12 with respect to the point P12 is smaller than a critical angle. One means for controlling the incident angle i12 is the angular difference Δθ between the outer surface 51 and the inner surface 52. The angular difference Δθ is set to a value within a predetermined range so that the incident angle i12 can be smaller than the critical angle.

Therefore, the external light L2 is emitted from the point P12 to an external space as indicated by an arrow AR3. The cover 5 of the present embodiment is designed to direct emitted light L22 toward the facing 130. More specifically, the angular difference Δθ of the cover 5 is a value at which, in a case where the external light L2 incident from the outer surface 51 is reflected by the inner surface 52, the reflected external light L2 is emitted from the outer surface 51 toward the facing 130. That is, the shape of the cover 5 is a shape in which the external light L2 incident on the inside of the cover 5 can be collected on the facing 130. Therefore, the cover 5 can suppress occurrence of ghosting due to the external light L2.

As described above, the cover 5 of the present embodiment can suppress total reflection of the external light L2 inside the cover 5 while correcting image distortion and aberration by the shape of the inner surface 52. Therefore, the vehicle display device 1 of the present embodiment can improve display quality of a virtual image while suppressing occurrence of ghosting due to external light.

As described above, the vehicle display device 1 of the present embodiment includes the housing 2, the image display device 3, the mirror 4, and the transparent cover 5. The housing 2 is mounted on the vehicle 100 and has the opening 21 facing the windshield 110. The image display device 3 is a device that is disposed inside the housing 2 and outputs the display light Lt of the image. The mirror 4 is disposed inside the housing 2 and faces the windshield 110 through the opening 21 of the housing 2. The mirror 4 reflects the display light Lt toward the windshield 110. The cover 5 is disposed in the opening 21 of the housing 2.

The cover 5 has the outer surface 51 facing the windshield 110 and the inner surface 52 facing the mirror 4. The cover 5 has a shape curved toward the inside of the housing 2 in the cross section orthogonal to the image lateral direction. The inner surface 52 is a free-form surface formed to correct image distortion or aberration.

The angular difference Δθ between the outer surface 51 and the inner surface 52 in the cross section orthogonal to the image lateral direction is set to a value within a range in which external light incident on the inside of the cover 5 from the outer surface 51 is not totally reflected inside the cover 5. The cover 5 of the present embodiment can improve display quality of a virtual image by correcting image distortion or aberration. Furthermore, the cover 5 of the present embodiment is configured not to totally reflect external light incident from the outer surface 51 inside the cover 5. Therefore, the vehicle display device 1 of the present embodiment can achieve both improvement in image quality and suppression of ghosting.

The vehicle display device 1 of the present embodiment is disposed in such a way that the cover 5 is positioned on the rear side of the vehicle and behind the facing 130. The facing 130 is an example of the light-blocking wall. The shape of the outer surface 51 of the cover 5 is a shape that reflects the external light L1 toward the facing 130. The angular difference Δθ is set to a value at which, in a case where the external light L2 incident on the inside of the cover 5 from the outer surface 51 is reflected by the inner surface 52, the reflected external light L2 is emitted from the outer surface 51 toward the facing 130. Therefore, the cover 5 of the present embodiment can collect the external light L1 and the external light L2 on the facing 130 to suppress occurrence of ghosting.

The cover 5 may be configured not to totally reflect the external light L2 at least on the outer surface 51. For example, the inner surface 52 of the cover 5 illustrated in FIG. 4 may be designed to allow total reflection of the external light L2 at the point P11 and not to totally reflect the external light L2 at the point P12. Such a cover 5 can effectively prevent the external light L2 from entering the inside of the housing 2.

In the vehicle display device 1 of the present embodiment, aberration correction is performed by the inner surface 52 of the cover 5. Therefore, it is possible to increase an enlargement magnification of the mirror 4 while maintaining the display quality. Therefore, it is possible to downsize the entire vehicle display device 1 by downsizing the mirror 4 and the image display device 3.

The contents disclosed in the above embodiment can be appropriately combined and executed.

The cover of the vehicle display device according to the present embodiment has the outer surface facing the windshield and the inner surface facing the mirror. The inner surface is a free-form surface formed to correct image distortion or aberration. The angular difference between the outer surface and the inner surface in the cross section orthogonal to the image lateral direction is set to a value within a range in which external light incident on the inside of the cover from the outer surface is not totally reflected inside the cover. The vehicle display device according to the present invention has an effect of achieving both improvement in image quality and suppression of ghosting.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
a housing that is mounted on a vehicle and has an opening facing a windshield;
an image display device that is disposed inside the housing and outputs display light of an image;
a mirror that is disposed inside the housing, faces the windshield via the opening, and reflects the display light toward the windshield; and
a transparent cover that is disposed in the opening, wherein
the cover has an outer surface facing the windshield and an inner surface facing the mirror, and has a shape curved toward an inside of the housing in a cross section orthogonal to an image lateral direction,
the inner surface is a free-form surface formed to correct distortion or aberration of the image, and
an angular difference between the outer surface and the inner surface in the cross section is set to a value within a range in which external light incident on an inside of the cover from the outer surface is not totally reflected inside the cover.

2. The vehicle display device according to claim 1, wherein
the housing is disposed in such a way that the cover is positioned on a rear side of the vehicle and behind a light-blocking wall provided in the vehicle,
the outer surface has a shape that reflects the external light toward the light-blocking wall, and
the angular difference is set to a value at which, in a case where the external light incident on the inside of the cover from the outer surface is reflected by the inner surface, the reflected external light is emitted from the outer surface toward the light-blocking wall.
